(19) United States
(12) Patent Application Publication
(10) Pub. No.: US 2017/0147785 A1
(43) Pub. Date: May 25, 2017

(54) SYSTEMS AND METHODS FOR TRACKING INVENTORY AND DISTRIBUTION OF MEDICATIONS IN A HEALTHCARE FACILITY

(71) Applicant: TOUCHPOINT MEDICAL, INC., Concordville, PA (US)

(72) Inventors: John G. Nackley, Wilkes-Barre, PA (US); Robert Sobie, Wilkes-Barre, PA (US); Jeffrey C. Olson, Wilkes-Barre, PA (US); Graham Ross, Wilkes-Barre, PA (US)

(73) Assignee: TOUCHPOINT MEDICAL, INC., Concordville, PA (US)

(21) Appl. No.: 15/323,203

(22) PCT Filed: Jun. 29, 2015
(86) PCT No.: PCT/US15/38229

§ 371 Date: Dec. 30, 2016

Related U.S. Application Data
(60) Provisional application No. 62/018,711, filed on Jun. 30, 2014.
(60) Provisional application No. 62/021,453, filed on Jul. 7, 2014.
(60) Provisional application No. 62/021,477, filed on Jul. 7, 2014.

(51) Int. Cl. G06F 19/00; G06F 17/30; G06Q 10/08

(52) U.S. Cl. CPC G06F 19/3462; G06Q 10/087; G06F 19/322; G06F 17/30377; G06F 17/3056

(57) ABSTRACT

A medication system includes a control module that determines when a medication is removed from a central pharmacy or a medication base station. The medication is carried by the healthcare professional and/or placed in a mobile workstation. A remote medication database, separate from a central inventory database associated with the healthcare facility, stores information about a total stock of the medication and respective stock quantities of the medication located in the central pharmacy, in the medication base station, carried by the healthcare professional, and/or placed in the mobile workstation. The total stock and the respective stock quantities are updated by the control module in response to a determination that that medication was removed from the central pharmacy or the medication base station. The control module updates the remote medication database in response to the medication being administered and updates the central inventory database.

### CROSS-REFERENCE TO RELATED APPLICATIONS

This application claims the benefit of U.S. Provisional Application No. 62/018,711, filed on Jun. 30, 2014. The entire disclosure of the application referenced above is incorporated herein by reference.

### FIELD

The present disclosure relates to systems and methods for managing the storage and distribution of pharmaceuticals and medical supplies in a healthcare facility.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In a healthcare facility, pharmaceuticals (i.e., medications) and other medical supplies are distributed from a central distribution location (e.g., a central pharmacy) using a medication management system. Medication management systems may be classified as centralized medication management systems or decentralized medication management systems. For example, in a centralized medication management system, medications may be provided from the central pharmacy directly to a healthcare professional (e.g., a nurse) that will be administering the medications to respective patients.

Conversely, in a decentralized medication management system, multiple medication dispensing sites are located remotely from a centralized distribution location, such as a facility's pharmacy. The remote dispensing sites, such as a nurses' station in a hospital ward, serve as base stations from which healthcare professionals can readily access medications or other medical supplies to be administered to the patients under their care.

A decentralized medication management system may implement a decentralized medication dispensing system (MDS). An MDS can comprise a cabinet having a plurality of storage compartments, such as drawers, shelves, or bins, for example. The storage compartments are stocked with individual medications and/or medication doses or other medical supplies by the pharmacy. The contents of the base stations are thoroughly inventoried and the distribution of medications and medical supplies is carefully controlled. Access to the MDS (and to the individual storage compartments in the MDS) is limited and can be gained only by healthcare professionals with the appropriate credentials. A user interface controls access to and records the inventory, and distribution of the medications and medical supplies from the MDS can be computer controlled.

In some implementations, the MDS may correspond to an automated dispensing machine (ADM) that stores medications in secure transportable compartments. The compartments may be loaded (i.e., stocked with medications) in the pharmacy and then transported to the ADM. A nurse removes medications from the compartment at the ADM and transports the medications (e.g., in a pocket) to the patient and administers the medication.

### SUMMARY

Systems and methods according to the principles of the present disclosure relate to tracking medications in a healthcare facility from the central pharmacy to the patient. For example, after medications are removed from a medication base station (e.g., an ADM) and transferred to and/or stored in a transport apparatus (e.g., a patient specific drawer, portable container, bin, compartment and/or mobile point-of-care (POC) workstation) and/or are otherwise under the control of a healthcare professional, and prior to the medications being administered to the patient, inventory data, including the in-stock quantities and locations of the medications can be tracked and/or monitored and recorded by a medication system. A central inventory database storing comprehensive inventory data, for the stock of medications throughout the healthcare facility, is not updated to reflect any changes to the in-stock quantities of medications in inventory until the medication system communicates to the central inventory database that the medication has been administered to the patient or otherwise disposed of by the healthcare professional.

The medication system includes a control module that determines when a medication is removed from a central pharmacy and/or a medication base station for administration to a patient, such as by a healthcare professional according to a healthcare facility's medication management system protocols. Upon removal from of the medication from the central pharmacy and/or the medication base station, the medication is transferred to and/or stored in a transport apparatus under the control of the healthcare professional for securely transporting medications to a patient care area (e.g., the patient's bedside) and administering the medications to the patient as prescribed. The transport apparatus can include, for example, a patient specific drawer, portable container, or mobile POC workstation, and/or are otherwise under the control of a healthcare professional. A remote, patient-specific medication database, separate from the central inventory database associated with the healthcare facility, stores or has access to inventory data for the medications in the healthcare facility, including, for example, the quantities of the medications located in the central pharmacy and/or in the medication base station. In addition, the local medication inventory database records and/or stores inventory data including the quantities and locations of the medications in the transport apparatus and not yet administered to a patient.

The control module can track and/or monitor when medications are removed from the central pharmacy and/or the medication base station and placed in the transport apparatus and update the inventory data in the remote medication database accordingly, including the in-stock quantities of the medications in the transport apparatus. The control module can also track and/or monitor when medications are administered by the healthcare professional to the patient and update the inventory data in the remote medication database accordingly. The control module can then update the inventory data in the central inventory database based on the updated inventory data of the remote medication database of the medication system.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is an example ADM;

FIG. 2 is an example mobile POC workstation;

FIG. 3 is an example medication management system including a medication system according to the principles of the present disclosure;

FIG. 4 is an example medication system according to the principles of the present disclosure;

FIG. 5 illustrates example information stored by a remote medication database according to the principles of the present disclosure; and

FIG. 6 illustrates and example medication method according to the principles of the present disclosure.

In the drawings, reference numbers may be reused to identify similar and/or identical elements.

### DETAILED DESCRIPTION

In a medication management system (e.g., a centralized, decentralized, and/or hybrid medication management system), inventory data for the medications maintained within a healthcare facility may be stored in a medication inventory database. Inventory data can include information about the in-stock quantities and storage locations of the stock of medications on-hand in the healthcare facility. Typically, the inventory data corresponds to medications stored in a central pharmacy and, in a decentralized medication management system, medications stored in medication base stations (e.g., ADMs) distributed throughout the healthcare facility. For example, the central inventory database may store inventory data including information about, inter alia, the stock on-hand of unit dose packages of medications and their locations in the facility. The inventory data can be indexed and/or tallied by medication type and/or location (e.g., whether the medication is in the central pharmacy or in a particular medication base station).

The medication management system generally updates the inventory data for the medications when a healthcare professional (e.g., a nurse) removes a unit (e.g., a dose) of the medication from any of the medication base stations for administering the medication to a patient according to facility protocols. For example, the total stock for the medication may be reduced by the number of units of the medication that are removed from the medication base station. In other words, the medication management system may consider that the medication is removed from inventory even before the medication has been administered to a patient, or otherwise disposed of by the healthcare professional (e.g., “wasted”). As such, there can exist a discrepancy between the inventory data reflected in the central inventory database and the actual stock on-hand of the medication in the healthcare facility. Typically, then, it is after the medication is administered to the patient by the healthcare professional according to facility protocols that an electronic Medical Administration Record (eMAR) is generated and the discrepancy in the inventory data of the central inventory database can be resolved.

Accordingly, the central inventory database generally may not track and/or monitor the inventory data for medications that are in transit between a medication base station and a patient care area.

Systems and methods according to the principles of the present disclosure relate to tracking and/or monitoring the medications in a healthcare facility from the central pharmacy all the way to the patient (e.g., the patient bedside or other patient care area). For example, when a medication is removed from a medication base station and placed in a transport apparatus, the in-stock quantity and location of the medication can be tracked and/or monitored (e.g., at predefined intervals or in real-time) through the administering of the medication to the patient. Although examples of the systems and methods are described herein with respect to decentralized medication management systems, the principles of the present disclosure may be implemented in centralized medication management systems and/or hybrid medication management systems, as well.

For example only, an update to the inventory data of the central inventory database may not be made in response to the healthcare professional removing a medication from the pharmacy or medication base station. Instead, the corresponding inventory data reflected in the central inventory database, including the stock on-hand, may not be updated until the medication is actually administered to the patient. For example, a separate medication system may continue to monitor the quantities and locations of the medication and generate and/or store that inventory data in a remote, patient-specific medication database. The inventory data may include, but is not limited to, information about the identity of the healthcare professional that removed the medication from the medication base station, the identity of the transport mechanism (e.g., a POC workstation) to which the medication was transferred, a location within the healthcare facility of the medication (e.g., where it is and/or where it is being transported), etc. The medication system may be in continuous, conditional, and/or periodic communication with the medication inventory database.

For example only, the medication system may record inventory data reflecting that the medication was removed from the medication base station and transferred to and/or stored in a transport apparatus for subsequent administration to a patient without also updating the total quantity inventory data in the central inventory database. Accordingly, the inventory data in the central inventory database may reflect the medication withdrawn from the medication base station that is in transit for administration to a patient as still included within the stock on-hand in the medical base station. Or, the inventory data of central inventory database may still include the withdrawn medication as part of the stock on-hand in the healthcare facility, while also indicating that the medication was removed from the medication base station. The medication system may subsequently inform the central inventory database (and/or the medication base station) when the medication is administered or otherwise disposed of (i.e., “wasted”) by the healthcare professional. The central inventory database may then update its inventory data, including the stock quantities of the medication throughout the facility and/or the status of the medication (e.g., administered to a patient or wasted).

In this manner, the medication systems and methods according to the principles of the present disclosure track and/or monitor, separately from and supplemental to a central inventory database, the stock quantities, locations, and statuses of medications, and particularly medications removed from medication base stations and transferred to transport apparatus for subsequent administering to patients. Accordingly, current information is maintained about medications removed from medication base stations but not yet administered to respective patients.

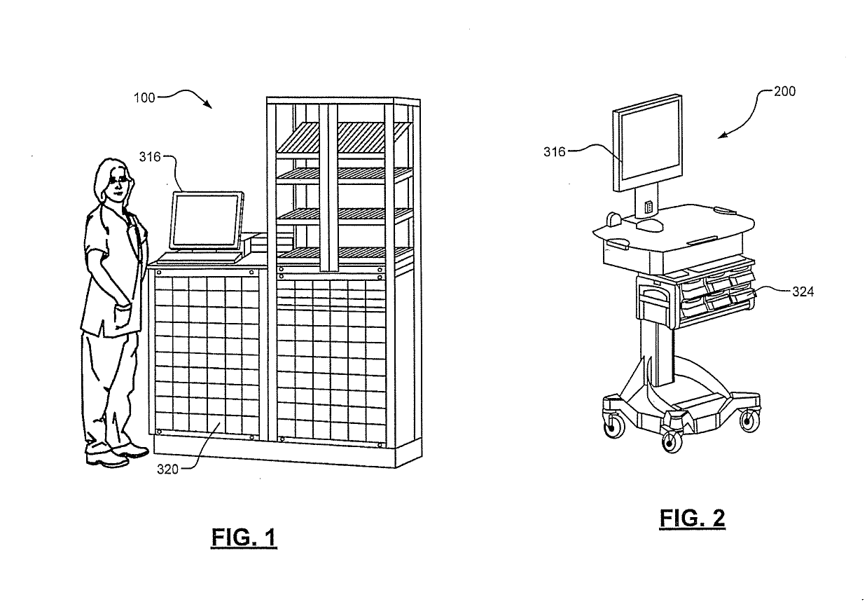

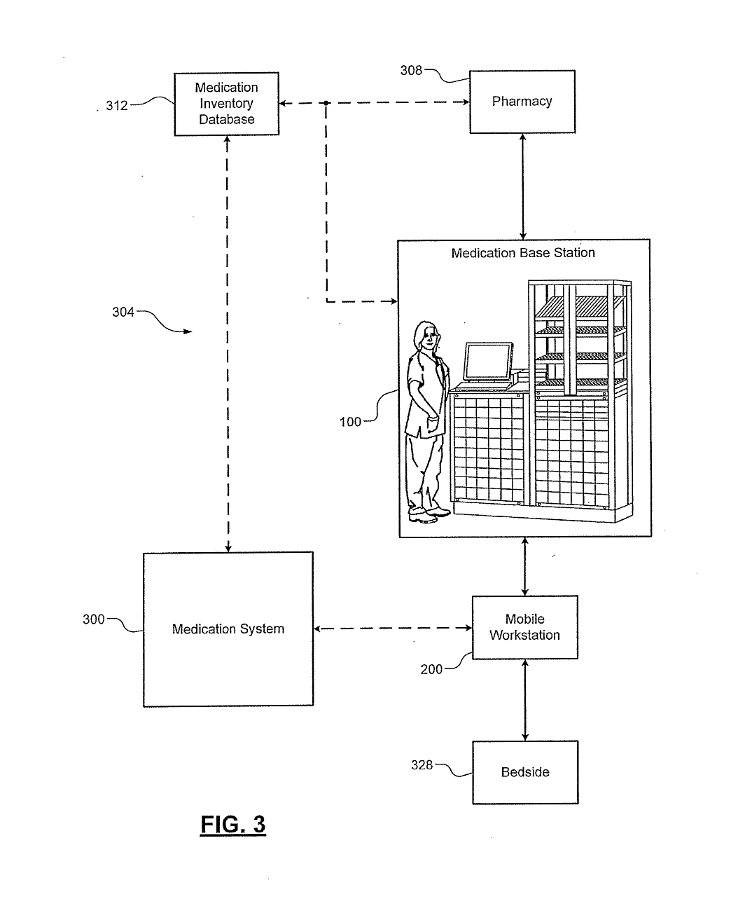

Referring now to FIGS. 1-3, FIGS. 1 and 2 show an example medication base station 100 and mobile POC workstation 200, respectively. FIG. 3 shows an example medication system 300 according to the principles of the present disclosure operating within a medication management system 304. While the medication management system 304 is described as a decentralized medication management system, the medication system 300 may also be implemented in a centralized medication management system or hybrid medication management system. Accordingly, as described, the example medication management system 304 includes the medication base station 100 and the mobile workstation 200.

In an example implementation, medications are provided from a central pharmacy 308 to one or more medication base stations 100. A central inventory database 312 stores inventory data about the medications, such as stock quantities of each medication available in the healthcare facility, locations of the medications (e.g., stock quantities of each medication in the central pharmacy 308 and/or in respective medication base stations 100, etc.). At the medication base station 100, the healthcare professional accesses either the mobile workstation 200 or the medication base station 100 according to facility protocols (e.g., by utilizing a user access control module 316 on one of the workstation 200 or base station 100). The healthcare professional then obtains information related to one or more medications prescribed for a particular patient. The information about patient specific medication is placed in a queue that can be accessed by the control module 316, as appropriate.

In one example implementation, as the healthcare professional approaches the base station 100 with the mobile workstation 200, the base station 100 and the workstation 200 may negotiate a communication link. After the communication link is secured, the base station 100 receives or reads the information in the queue containing the information about patient-specific medication and prescription information for a given patient. The base station 100 then enables access by the healthcare professional to respective storage locations (e.g., drawers 320) containing the particular medications for that patient. At the same time the mobile workstation 200 enables access by the healthcare professional to the patient specific drawer 324 for that patient on the mobile workstation 200.

The healthcare professional then retrieves the medications from the drawers 320 of the base station 100 and may record the retrieval activity according to facility protocols. The healthcare professional then places those medications in the patient-specific drawer 324 on the mobile workstation 200 and may record that activity according to facility protocols. These steps are repeated for each of the medications for the patient that are retrieved from the base station 100 and placed in the patient specific drawer 324 on the mobile workstation 200. Then the steps may also be repeated for any number of patients under the care of the healthcare professional.

The healthcare professional can thereafter administer the medications to the patient at the patient's bedside 328. For example, the healthcare professional transports the mobile workstation 200 to the patient. At that time, the healthcare professional can access the mobile workstation 200 according to facility protocols utilizing the control module 316 on the workstation 200. The healthcare professional then selects the patient for administration of medications. The control module 316 then enables access by the healthcare professional to the patient-specific drawer 324 containing the medications for that patient. The healthcare professional then removes the medications from the patient-specific drawer 324 and administers the medications to the patient according to facility protocols (e.g., according to the well-known “five rights” protocol). This may include using the control module 316 to record that the medications have been administered. Once the medications are administered to the first patient, the healthcare professional can then proceed to successive patients whose medications are contained in the mobile workstation 200, if any.

Either or both of the medication base station 100 and the mobile workstation 200 may be configured to communicate with peripheral devices, such as bar code readers, PDAs, biometric security devices (e.g., a fingerprint scanner), scanners, card readers, keyboards, RFID systems, and the like. The medication base station 100 and/or the mobile workstation 200 (e.g., via respective control modules 316) may implement the operating protocols of the healthcare facility for managing the distribution of medications from a pharmacy to a patient.

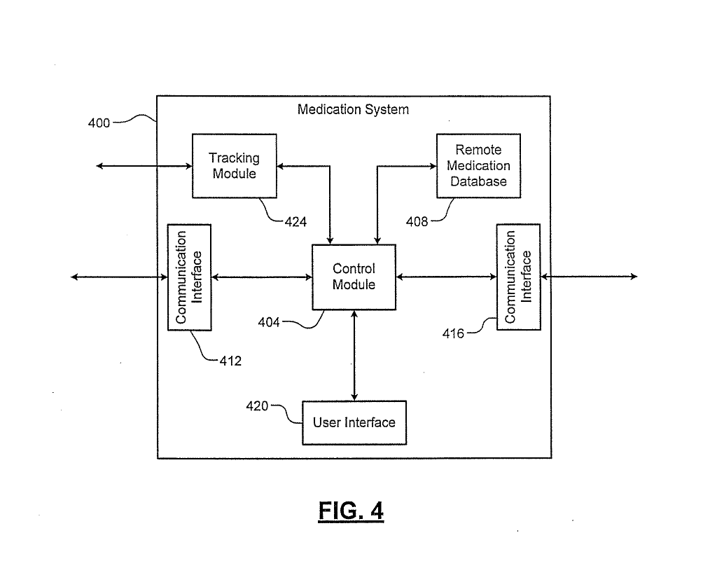

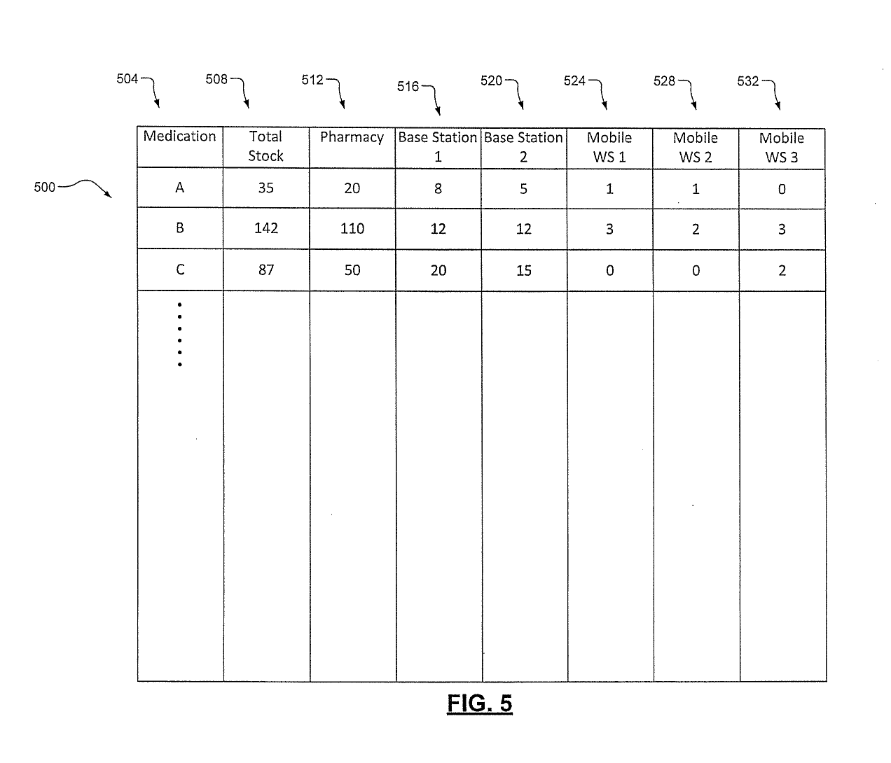

While the central inventory database 312 stores, for example, the inventory data including stock quantities for medications in the central pharmacy 308 and/or in the respective medication base stations 100, the medication system 300 separately monitors, tracks, generates and/or stores inventory data about medications removed from the medication base station 100 and transferred to and/or stored in the mobile workstation 200 (or another transport apparatus under the control of a healthcare professional). For example, the stock quantities of the medications in the healthcare facility that are maintained by the central inventory database 312 may typically be updated (e.g., diminished to reflect spent inventory) when the healthcare provider removes the medications from the medication base station 100. However, in the medication management system 304, the stock quantities of the medications are also maintained in the inventory data of a remote, patient-specific medication database 408 (shown in FIG. 4). The inventory data of the remote medication database 408 are not diminished merely in response to the medication being removed from the medication base station 100. Instead, the remote medication database 408 continues to reflect thatstock associated with the corresponding medication base station 100 still remains, and therefore is included within a total stock quantity of the facility, even while the central inventory database 312 may reflect a different (diminished) stock quantity.

The inventory data for the medications located in the mobile workstation 200 may also associate the medications with a particular healthcare provider (e.g., the healthcare provider that removed the medication from the medication base station 100), a particular patient, and/or a location of the mobile workstation 200. For example only, the location of the mobile workstation 200 may be determined based on a predetermined portion of the healthcare facility assigned to the mobile workstation 200, by RFID or another real time location system (RTLS), WLAN communication, etc.

The medication system 300 is in communication with one or more of the central inventory database 312, the medication base station 100, and/or the mobile workstation 200 to maintain and selectively update the stock quantities of the medications in the healthcare facility recorded in the central inventory database 312. For example, the medication system 300 may inform the central inventory database 312 to update the inventory data, including the stock quantities of a medication, only after receiving confirmation from a healthcare professional that the medication was administered to the patient or otherwise disposed (i.e., “wasted”). The central inventory database 312 may then update the stock quantities and/or status of the medication.

Although schematically shown separate from the medication base station 100 and the mobile workstation 200, the medication system 300 may be a separate device or module (e.g., implemented within a handheld device), or may be implemented within the medication base station 100 and/or the mobile workstation 200 (e.g., within respective control modules 216).

Referring now to FIG. 4, a schematic representation of an example medication system 400 includes a control module 404, a remote, patient-specific medication database 408, communication interfaces 412 and 416, a user interface 420 (e.g., a graphical user interface), and an optional tracking module 424. The control module 404 controls and coordinates communication and processing of information between the remote medication database 408, the communication interfaces 412 and 416, the user interface 420, and the tracking module 424. For example, the control module 404 receives information about various medications removed from medication base stations 100 and transferred and/or stored in mobile workstations 200 via the communication interface 416 and/or the user interlace 420, receives information about locations of a mobile workstation 200, medications removed from medication base stations 100, healthcare professionals, and/or various devices implemented the medication system 400 from the tracking module 424, and stores the information to and retrieves the information from the remote medication database 408. The control module 404 also provides information to be communicated via the communication interfaces 412 and 416 and the user interface 420.

The user interface 420 allows a user (e.g., a healthcare professional) to interact with the medication system 400 and may include, for example only, a display (e.g., for a graphical user interface), user input controls, etc. In implementations where the medication system 400 is incorporated in the medication base station 100 or the mobile workstation 200, the user interface 420 may correspond to a user interface of the control modules 316. The healthcare professional may input information according to facility protocols, such as, for example, identity authentication and/or security credentials, medication removed from the medication base station 100, medication administered to respective patients, etc.

The communication interface 412 exchanges information with the central inventory database 412, and the communication interface 416 exchanges information with the medication base station 100 and/or the mobile workstation 200. For example only, the communication interfaces 412 and 416 may communicate using WiFi or other WLAN signals, Bluetooth, various wired communication protocols, or any other suitable long or short range communication protocols.

The tracking module 424 may implement RFID or another RTLS to determine a location of a device implementing the medication system 400. The location of the device (which may be associated with a particular medication removed from the medication base station 100) may be recorded in the inventory data generated and/or stored in the remote medication database, communicated to the central inventory database 312 via the communication interface 412, and/or communicated to the medication base station 100 and/or the mobile workstation 200 via the communication interface 416. In some implementations, the device implementing the medication system 400 corresponds to the mobile workstation 200.

The control module 404 may receive information related to removal of a medication from the medication base station 100 (and, in some implementations, therefore stored in the mobile workstation 200). For example, the control module 404 may learn that the medication is removed from the medication base station 100 via automatic communication transmitted from the medication base station 100 (via the communication interface 416) that can be selectively triggered by the a drawer 320 being opened, a medication being removed from the drawer 320, a healthcare professional inputting information (via user interface 420, one of the control modules 316, etc.) indicating that the medication was removed from the medication base station 100 or that the medication was placed in a patient specific drawer 324, the patient specific drawer being opened and/or the medication being placed therein, etc. It can be appreciated that the above are only several examples describing how the control module 404 may determine when a medication is removed from the medication base station 100 and that other implementations are anticipated.

The control module 404 records information about the medication in the remote medication database 408. For example only, the remote medication database 408 may be implemented using memory located on a handheld device including the medication system 400. For example, the remote medication database 408 may store information about stock quantities of medications in the healthcare facility consistent with the stock quantities stored in the central inventory database 312, and/or stock quantities of the medications in respective medication base stations 100. The remote medication database 408 may store further information about medication removed from the pharmacy and/or the base station 100 and placed in the mobile workstation 200. This further information may indicate various stock quantities (and locations) of medications that still reside in the healthcare facility, but not in the pharmacy 308 or a base station 100. In other words, the remote medication database 408 records further information indicating an amount of a medication that has been removed from respective base stations 100 and has not yet been administered to a patient or otherwise disposed. Accordingly, the further information indicates an amount (and a location) of the medication that is located in various mobile workstations 200, that is being carried by a healthcare professional, etc.

The central inventory database 312 may store information about the stock quantities of the medication, but may not reflect the amount of the medication still in the healthcare facility but not yet administered to a patient. For example, in a typical medication management system the central inventory database may reduce the stock quantities of the medication when the medication is removed from the base station 100 even though the medication has not been administered or otherwise disposed (e.g., is in a mobile workstation 200). Conversely, according to the principles of the present disclosure, the central inventory database 312 maintains (i.e., does not reduce) the stock quantities of the medication upon removal of the medication from the base station 100. Instead, the medication system 400 stores, in the remote medication database 408, information indicating that the stock quantities of the medication in the healthcare facility is the same, but some portion of the medication is now in transport between a respective base station 100 and a patient's bedside 328. Accordingly, the remote medication database 408, and consequently the central inventory database 312, has more robust and accurate information about the total inventories of various medications within the healthcare facility.

Once the healthcare professional has administered the medication, the remote medication database 408 can be updated, accordingly, to reflect the actual reduction in the stock quantities of the medication in the healthcare facility (i.e., to reflect an actual inventory changing event). For example, the stock quantities of the medication, as recorded in the inventory data of the remote medication database 408, is reduced by an amount of the medication administered. A corresponding stock quantity of the medication in the mobile workstation 200 is also reduced. The remote medication database 408 may be updated according to user input at the user interface 420, automatically in response to a predetermined protocol being followed (e.g., bar codes associated with the patient, medication, healthcare professional, etc. being scanned as part of a medication administration protocol), and/or another suitable condition.

The medication system 400 may then update the central inventory database 312 (via the communication interface 412) to adjust the stock quantities of the medication in the healthcare facility. For example, the medication system 400 may update the central inventory database 312 automatically upon confirmation that the medication was administered or disposed of, on a periodic (e.g., real time) basis, and/or in response to some other condition (e.g., in response to a prompt from a healthcare professional at the base station 100 and/or the mobile workstation 200).

In embodiments, the medication base station 100, the mobile workstation 200, and/or another storage or transport item may include a compartment (e.g., the drawer 324, a removable module or cassette, etc.) movable between an open configuration and a closed configuration. Contents (e.g., medication and/or other items) may be transferred to and from the compartment in the open configuration. Conversely, the contents of the compartment are not accessible in the closed configuration.

The control module 404 may communicate with the compartment (e.g., electronically, wirelessly, etc.). When a medication prescribed to a certain patient is to be loaded into the compartment, the control module may receive an association signal that identifies the patient and store (e.g., a patient-specific database within the remote medication database 408 and/or the medication inventory database 312), based on the association signal, an association between the patient and the compartment. The association signal may be generated upon access to the medication base station 100, the medication system 300, etc. by a healthcare professional.

The control module 404 may then receive a load signal identifying the medication prescribed to the patient and, upon verification that the medication is indeed prescribed to the patient associated with the compartment, (e.g., via the patient-specific database), cause the compartment to move to the open configuration to allow the healthcare professional to load the medication. The control module 404 stores (e.g., in the patient-specific database) information indicating that the prescribed medication is now stored in the compartment. In embodiments, the control module 404 may also inform the medication inventory database 312 that the medication is stored within the compartment in the medication management system 304. The compartment may then be transitioned to the closed configuration after the medication is placed therein. Subsequently, the control module 404 may receive a dispense signal (prompted by the healthcare professional attempting to access the compartment to administer the medication to the patient). The control module 404 changes the compartment to the open configuration in response to the dispense signal.

The healthcare professional can then access the compartment to remove the medication and administer the medication to the patient. The healthcare professional may provide some indication that the medication was administered to the patient (e.g., via the user interface 420), causing an administration signal to be provided to the control module 404. The control module 404 can then update the patient-specific database (and/or the medication inventory database) accordingly.

Referring now to FIG. 5, example information 500 stored by the remote medication database 408 includes a medication type 504, a total stock quantity 508 of the medication in the healthcare facility, an amount 512 of the of the medication in the pharmacy, amounts 516 and 520 of the medication in respective base stations (1 and 2), and respective amounts 524, 528, and 532 of the medication in respective mobile workstations (WS 1, 2, and 3). Accordingly, the total stock quantity 508 corresponds to a tally or sum of the stock quantities 512, 516, 520, 524, 528, and 532. In contrast, the central inventory database 312 may only store information about the total stock quantity 508, the amount 512 of the medication in the pharmacy, and the amounts 516 and 520 of the medication in the respective base stations 100. When a particular medication is administered as described above, the remote medication database 408 is updated accordingly. For example, as medication is administered, the amount of the medication in a particular one of the mobile workstations 200 is updated, and the total stock quantity 508 is reduced accordingly. The medication system 400 then updates the central inventory database 312 with the updated total stock quantity 508 stored in the remote medication database 408.

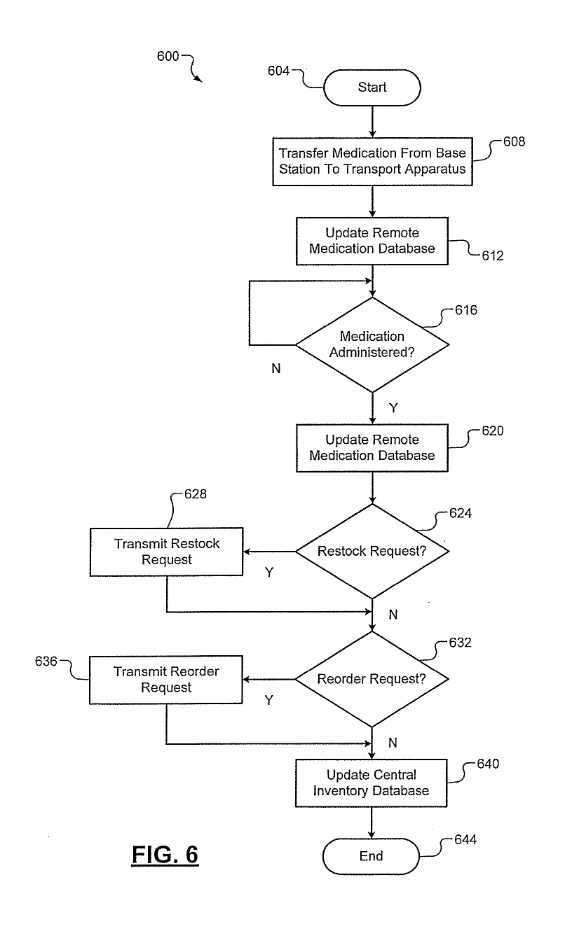

Referring now to FIG. 6, an example medication method 600 begins at 604. At 608, a healthcare professional removes a medication from a central pharmacy or a medication base station 100 and transfers the medication to a transport apparatus, e.g., according to a facility-approved protocol. At 612, the method 600 updates a remote medication database 408 (separate from a central inventory database 312 associated with the medication management system of the healthcare facility) according to the medication removed from the pharmacy/base station. At 616, the method 600 determines whether the medication has been administered to a patient or otherwise disposed. If true, the method 600 continues to 620. If false, the method 600 continues to 616. At 620, the method 600 updates the remote medication database 408 to reflect that the medication was administered.

In some implementations, at 624, 628, 632, and 636 the method 600 may optionally generate and transmit a medication restock request, e.g., to the central pharmacy, and/or a medication reorder request, e.g., to the central pharmacy and/or a third party pharmaceuticals supplier, based on the updated remote medication database 408. For example, at 624, the method 600 determines whether to generate a restock request to the central pharmacy to restock the medication base station 100. For example only, the method 600 may generate the restock request if the administration of the medication, as confirmed at 616, results in the stock quantity of the medication located in the medication base station 100 to decrease below a predetermined threshold. If the result of 624 is true, the method 600 transmits the restock request to the central pharmacy 308 to cause the central pharmacy 308 to have the medication base station 100 restocked. If false, the method 600 continues to 632.

As a further example, at 632, the method 600 determines whether to generate a reorder request to obtain new stock of the medication for the healthcare facility. For example only, the method 600 may generate the reorder request if the administration of the medication, as confirmed at 616, results in the total stock of the medication in the healthcare facility to decrease below a predetermined threshold. If the result of 632 is true, the method 600 transmits the reorder request to a third party pharmaceuticals supplier outside of the healthcare facility and/or to the central pharmacy. If false, the method 600 continues to 640.

At 640, the method 600 updates the central inventory database 312 according to the information stored in the remote medication database 408. The method 600 ends at 644.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

What is claimed is:

1. A medication system, comprising:
a compartment movable between an open configuration wherein content of the compartment is accessible and a closed configuration wherein the content of the compartment is not accessible;
a patient-specific database;
a control module coupled to the patient-specific database and configured to be operably coupled to the compartment, the control module configured to:
accept an association signal that comprises an identification of a patient and record in the patient-specific database an association of the compartment with the patient;
accept a load signal that comprises identification of at least one medication that is prescribed for the patient and, upon receipt of the load signal, cause the compartment that is associated with the patient to move to the open configuration and record in the patient-specific database that the at least one medication is contained in the compartment and cause a message to be sent to a medication inventory database that the at least one medication is stored in the medication system; and
accept a dispense signal that comprises the identification of the patient and, upon receipt of the dispense signal, cause the compartment that is associated with the patient to move to the open configuration.

2. The medication system of claim 1, wherein the control module is further configured to:
accept an administration signal and, upon receipt of the administration signal, record in the patient-specific database that the content has been removed from the compartment and cause a message to be sent to the medication inventory database that the at least one medication has been administered.

3. The medication system of claim 1, wherein the patient-specific database is stored in a remote medication database separate from the medication inventory database, and wherein the medication inventory database corresponds to a central inventory database associated with a healthcare facility.

4. The medication system of claim 3, wherein the remote medication database stores information about respective quantities of the medication in different locations within the healthcare facility independent of a total stock of the medication in the healthcare facility.

5. The medication system of claim 4, wherein the different locations include at least one of the compartment, a medication base station, and a mobile workstation.

6. A medication method, comprising:
providing a compartment movable between an open configuration wherein content of the compartment is accessible and a closed configuration wherein the content of the compartment is not accessible;
storing, in a patient-specific database an identification of a patient and an association of the compartment with the patient;
upon receipt of a load signal identifying at least one medication that is prescribed for the patient, causing the compartment that is associated with the patient to move to the open configuration;
recording in the patient-specific database that the at least one medication is contained in the compartment;
causing a message to be sent to a medication inventory database that the at least one medication is stored in the compartment; and
upon receipt of a dispense signal identifying the patient, causing the compartment that is associated with the patient to move to the open configuration.

7. The medication method of claim 6, further comprising:
upon receipt of an administration signal, recording in the patient-specific database that the content has been removed from the compartment and causing a message to be sent to the medication inventory database that the at least one medication has been administered.

8. The medication method of claim 6, further comprising storing the patient-specific database in a remote medication database separate from the medication inventory database, wherein the medication inventory database corresponds to a central inventory database associated with a healthcare facility.

9. The medication method of claim 8, further comprising storing, in the remote medication database, information about respective quantities of the medication in different locations within the healthcare facility independent of a total stock of the medication in the healthcare facility.

10. The medication method of claim 9, wherein the different locations include at least one of the compartment, a medication base station, and a mobile workstation.

11. A medication system, comprising:
a control module that determines when a medication is removed, by a healthcare professional, from at least one of a central pharmacy and a medication base station within a medication management system of a healthcare facility, wherein, upon removal from the at least one of the central pharmacy and the medication base station, the medication is at least one of carried by the healthcare professional and placed in a mobile workstation; and
a remote medication database, separate from a central inventory database associated with the healthcare facility, that stores information about (i) a total stock of the medication in the healthcare facility, (ii) a quantity of the medication located in the central pharmacy and/or in the medication base station, and (iii) a quantity of the medication carried by the healthcare professional and/or placed in the mobile workstation but not yet administered by the healthcare professional to a patient, wherein the total stock, the quantity of the medication located in the central pharmacy and/or in the medication base station, and the quantity of the medication carried by the healthcare professional and/or placed in the mobile workstation is updated by the control module in response to the determination that the medication was removed from the at least one of the central pharmacy and the medication base station,
wherein the control module updates the remote medication database in response to the medication being administered, by the healthcare professional, to the patient, and
wherein the control module updates the central inventory database based on the updated remote medication database of the medication system.

12. The medication system of claim 11, wherein the control module is configured to transmit a medication restock request to at least one of the central pharmacy and a supplier based on the updated remote medication database.

13. The medication system of claim 11, wherein the control module is configured to transmit the medication restock request if the updated remote medication database indicates that the quantity of the medication located in the medication base station is less than a threshold.

14. The medication system of claim 12, wherein the medication restock request corresponds to a request to restock the medication base station.

15. The medication system of claim 11, wherein the control module is configured to transmit a medication reorder request to a supplier based on the updated remote medication database.

16. The medication system of claim 15, wherein the control module is configured to transmit the medication reorder request if the updated remote medication database indicates that the total stock of the medication in the healthcare facility is less than a threshold.

17. A medication method, comprising:
determining when a medication is removed, by a healthcare professional, from at least one of a central pharmacy and a medication base station within a medication management system of a healthcare facility, wherein, upon removal from the at least one of the central pharmacy and the medication base station, the medication is at least one of carried by the healthcare professional and placed in a mobile workstation;
storing, in a remote medication database separate from a central inventory database associated with the healthcare facility, information about (i) a total stock of the medication in the healthcare facility, (ii) a quantity of the medication located in the central pharmacy and/or in the medication base station, and (iii) a quantity of the medication carried by the healthcare professional and/or placed in the mobile workstation but not yet administered by the healthcare professional to a patient;
updating, in response to the determination that the medication was removed from the at least one of the central pharmacy and the medication base station, the total stock, the quantity of the medication located in the central pharmacy and/or in the medication base station, and the quantity of the medication carried by the healthcare professional and/or placed in the mobile workstation;
updating the remote medication database in response to the medication being administered, by the healthcare professional, to the patient; and
updating the central inventory database based on the updated remote medication database of the medication monitoring system.

18. The medication method of claim 17, further comprising transmitting a medication restock request to at least one of the central pharmacy and a supplier based on the updated remote medication database.

19. The medication method of claim 17, further comprising transmitting the medication restock request if the updated remote medication database indicates that the quantity of the medication located in the medication base station is less than a threshold.

20. The medication method of claim 18, wherein the medication restock request corresponds to a request to restock the medication base station.

21. The medication method of claim 17, further comprising transmitting a medication reorder request to a supplier based on the updated remote medication database.

22. The medication method of claim 21, further comprising transmitting the medication reorder request if the updated remote medication database indicates that the total stock of the medication in the healthcare facility is less than a threshold.
